(19) United States
(12) Patent Application Publication
(10) Pub. No.: US 2014/0310560 A1
(43) Pub. Date: Oct. 16, 2014

(54) METHOD AND APPARATUS FOR MODULE REPAIR IN SOFTWARE

(71) Applicants: Yuanzhen Ma, Beijing (CN); Baosheng Li, Beijing (CN); Weihua Tao, Beijing (CN)

(72) Inventors: Yuanzhen Ma, Beijing (CN); Baosheng Li, Beijing (CN); Weihua Tao, Beijing (CN)

(73) Assignee: Beijing Qihoo Technology Company Limited, Beijing (CN)

(21) Appl. No.: 14/008,278

(22) PCT Filed: Feb. 27, 2012
(86) PCT No.: PCT/CN2012/071682

§ 371 Date: Dec. 2, 2013

(30) Foreign Application Priority Data
Mar. 29, 2011 (CN) 201110076467.0

(51) Int. Cl. G06F 11/14; G06F 11/36; G06F 9/445

(52) U.S. Cl. CPC G06F 11/1479; G06F 8/65; G06F 11/3688
USPC 714/38.1

(57) ABSTRACT

The present application relates to a method and apparatus for module repair in software. In the method, when a module in the software has an error, correct content corresponding to the erroneous content is obtained by way of accessing a web page address; then the correct content obtained is directly loaded into a system memory and the corresponding correct content is invoked directly from the memory when the module is used. The method of the present application results in the software possessing a self-repairing function and self-detection function, and can be applied in any software device.

### FIELD OF THE INVENTION

The application relates to the electronic computer technology, and in particular, to a method and apparatus for module repair in software.

### BACKGROUND OF THE INVENTION

With the rapid development of the electronic computer technology, more and more people begin to use an electronic device such as a PC (personal computer), a PDA (personal digital assistant), a mobile phone, etc. to access the internet, be engaged in network activities, for example, browsing web page, chatting online, checking email, etc.

When people are using a software tool such as a browser, a chat tool, or a mailbox client, etc., once a certain module in the software tool (e.g., a browser) being used by a user is destroyed or an abnormality occurs to it, the user will not be able to continue using that module, and even cannot use the software tool (e.g., a browser) as a whole when the situation becomes severe. If the user wants to continue using such software tool, an action usually taken is to re-download such software tool and then install it. In such a way, the operation is relatively tedious, which brings about inconvenience to the user. Furthermore, if when the user is using a certain kind of software tool (e.g., a browser) to be engaged in important or emergent business, an abnormality occurs to the software tool, it will probably bring about trouble or even loss to the user.

In addition, when people are using a software tool (e.g., a browser), once the software has an error, it can only be perceived artificially, namely by human eyes, that an error has occurred to the software. Moreover, after it is found that the software has an error, neither can the erroneous content be repaired intelligently. Such a way may probably lead to crash of the software, since it can not detect timely that the software has an error, and neither makes a corresponding repair for the erroneous content. Furthermore, such a way in which it is perceived artificially that the software has an error and the erroneous content is repaired manually is tedious operationally, which brings about inconvenience to the user. Especially for those users who initially learn internet and only have simple internet knowledge, there is a certain difficulty under some circumstances in finding timely by them that an error has occurred to the software. However, if an error can not be found and repaired timely, the user will not be able to use the software tool normally, and thus it will be affected that the user studies, works or plays normally by the software tool.

### SUMMARY OF THE INVENTION

The application provides a method and apparatus for module repair in software. In the application, when a module in the software has an error, it may make self-repair by way of network, such that the software may be used normally. In the application, also the software may be self-detected by way of network, so as to avoid problems such as not timely, operationally tedious, etc. caused by detected manually.

In a first aspect, the application provides a method for module repair in software. When an abnormality occurs to a module in the software, detecting the abnormal module in the software and the abnormal content corresponding to the module, then downloading the normal content corresponding to the abnormal content, and invoking the corresponding downloaded normal content when said abnormal module is used.

Preferably, after the step of downloading the normal content corresponding to the abnormal content, also comprising loading directly the downloaded normal content into a system memory, then the step of invoking the corresponding downloaded normal content when said abnormal module is used is invoking directly from the memory the corresponding downloaded normal content when said abnormal module is used.

Preferably, the normal content corresponding to the abnormal content is downloaded by way of accessing a web page address.

Preferably, the downloaded normal content is a configuration file and/or a data file.

Preferably, the detecting step is checking for the correctness and/or integrality of part of or all the modules in the software.

Preferably, the detecting step comprises a step of scanning files related with the software.

Preferably, the scanning step comprises a step of extracting feature content portions in the files and generating a list of current files.

Preferably, the extraction of feature content portions employs an abstract-of-full-text algorithm.

Preferably, the detecting step further comprises a step of analyzing the list of current files according to a list of standard files.

Preferably, the analyzing step comprises matching the list of current files with the list of standard files, and when one or more items of content in the list of current files do not match the corresponding content in the list of standard files, judging that the software is abnormal, and a module corresponding to the unmatched content is an abnormal module in the software and the unmatched content is abnormal content.

Preferably, the analyzing step comprises matching the list of current files with the list of standard files, and when there lack in the list of current files one or more items of content in the list of standard files, judging that the software is abnormal, and a module corresponding to the lacked content is an abnormal module in the software and the lacked content is abnormal content.

Preferably, the list of standard files comprises the feature content portion of a correct file and a download address containing the correct file.

Preferably, before the step of downloading the normal content, also comprising presetting locally a directory storing correct data, and finding a download address for the downloading of the normal content according to the directory.

Preferably, the detecting step comprises detecting the software locally.

Preferably, the detecting step comprises requesting for detecting the software by way of accessing a web page address.

Preferably, the step of requesting for detecting the software by way of accessing a web page address comprises downloading through the web page address an analysis function for detecting an abnormality in the software, and detecting the software with the analysis function.

Preferably, before the step of requesting for detecting the software by way of accessing a web page address, also comprising a step of judging whether the software is normal or not, and if the software is abnormal, requesting for detecting the software by way of accessing a web page address, or according to a detection instruction issued by a user, requesting for detecting the software by way of accessing a web page address.

In a second aspect, the application provides an apparatus for module repair in software. The apparatus comprises a detecting module, an obtaining module and a repairing module. The detecting module is configured to, when an abnormality occurs to a module in the software, detect the abnormal module in the software and the abnormal content corresponding to the module; the obtaining module is configured to download the normal content corresponding to the abnormal content; and the repairing module is configured to invoke the corresponding downloaded normal content when said abnormal module is used.

Preferably, the apparatus further comprises a storing module configured to load directly the downloaded normal content into a system memory, and then the repairing module invokes directly from the memory the corresponding downloaded normal content when said abnormal module is used.

Preferably, the obtaining module downloads the normal content corresponding to the abnormal content by way of accessing a web page address.

Preferably, the detecting module comprises a scanning module and an analyzing module. The scanning module is configured to scan files related with the software, extract a feature content portion in a file each time the file is scanned, and generate a list of current files. The analyzing module is configured to match a list of standard files with the list of current files, and when one or more items of content in the list of current files do not match the corresponding content in the list of standard files, or when there lack in the list of current files one or more items of content in the list of standard files, judge that the software is abnormal, and a module corresponding to the unmatched content or the lacked content is an abnormal module in the software and the unmatched content or the lacked content is abnormal content.

Preferably, the detecting module is a first detecting module, and the first detecting module detects the software locally.

Preferably, the detecting module is a second detecting module which requesting for detecting the software by way of accessing a web page address, and the second detecting module downloads through the web page address an analysis function for detecting an abnormality in the software, and detects the software with the analysis function.

Preferably, when the detecting module is the second detecting module, also comprising a judging module, which is configured to judge whether the software is normal or not, and if the software is abnormal, the second detecting module requests for detecting the software by way of accessing a web page address, or according to a detection instruction issued by a user, the second detecting module requests for detecting the software by way of accessing a web page address.

In a third aspect, the application provides a computer readable record medium recording thereon a program for carrying out the method for module repair in software.

On the one hand, the application is capable of self-repairing a module in software that has had an error without a user having to find and download on the internet software of a correct version and install it, which provides convenience to the user and saves time. Furthermore, if the software is attacked maliciously by a virus, etc., since in the application the obtained normal content is directly loaded into a memory, but not stored locally, the normal content in the memory is not easily damaged by the virus and thus the stability is better. Moreover, such a way in which the normal content is directly loaded into a memory, but not stored locally, is faster in execution speed.

On the other hand, the application is further capable of self-detecting the software without a manual check, and therefore an error may be found more timely and accurately, and the user's experience is better.

### BRIEF DESCRIPTION OF THE DRAWINGS

In the following, the particular embodiments of the application will be described in detail with reference to appended drawings in which:

FIG. 1 is a flow chart of a method for self-repair in software in an embodiment of the application;

FIG. 2 is a flow chart of a method for self-repair in a browser in an embodiment of the application;

FIG. 3 is a block diagram of a software device for self-repair in an embodiment of the application;

FIG. 4 is a flow chart of a method for self-detection in software in another embodiment of the application;

FIG. 5 is a flow chart of a method for self-detection in a browser in another embodiment of the application;

FIG. 6 is a block diagram of a software device for self-detection in another embodiment of the application;

FIG. 7 is a flow chart of the method for module repair in software in another embodiment of the application;

FIG. 8 is a structure diagram of the apparatus for module repair in software in another embodiment of the application;

FIG. 9 is a structure diagram of the apparatus for module repair in software in another preferred embodiment of the application; and

FIG. 10 is a structure diagram of the apparatus for module repair in software in another preferred embodiment of the application.

### DETAILED DESCRIPTION OF THE INVENTION

FIG. 1 is a flow chart of a method for self-repair in software in an embodiment of the application.

In step 110, when a module in the software has an error, obtaining the correct content corresponding to the erroneous content by way of accessing a web page address.

In step 120, loading directly the obtained correct content into a system memory, but not storing locally, and invoking directly the corresponding correct content from the memory when the module is used.

Since in step 110 the correct content corresponding to the erroneous content is obtained by way of network (i.e., by way of accessing a web page address), the software possesses a self-repairing function and does not need a manual repair. Furthermore, since in step 120 the obtained correct content is loaded into a system memory without having to be stored locally, the software is faster in execution speed and its stability is better. When the software is attacked by a virus, leading to its module being damaged, the way in which the embodiment loads the correct content into the memory, but not stores it locally, is such that the correct content will not be damaged by the virus, and in turn it is ensured that the browser can be used normally.

Of course, that the obtained correct content is loaded into a system memory is a preferred implementation. In a further embodiment, it may also be that the obtained correct content is first stored on a local hard disk, and when said abnormal module is used, the corresponding correct content is read from the hard disk and loaded into the memory, and then invoked from the memory.

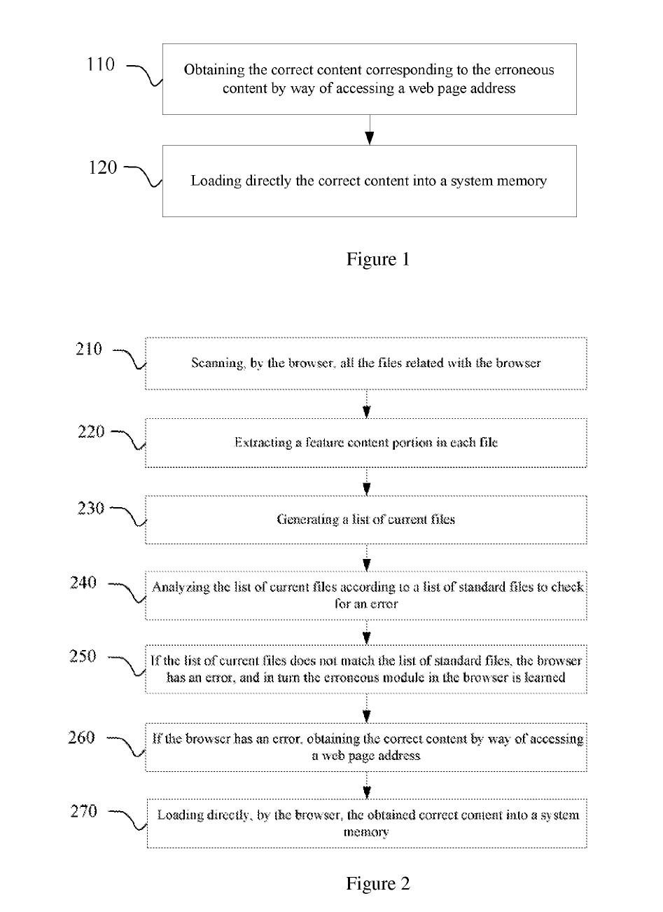

It needs to be noted that the software described in the embodiments of the application may be any software device such as a browser, a chat tool, or a mailbox client, etc. In FIG. 2, a browser is taken as an example to further elucidate the method for repair in software in FIG. 1.

FIG. 2 is a flow chart of a method for self-repair in a browser in an embodiment of the application.

Step 210 to step 250 as a whole is a particular embodiment in which a browser is detected and when the browser has an error, an erroneous module in the browser is found. The application is not limited to such a detection mode.

In step 210, the browser scans all the files related with the browser, including scanning all the files under the installation directory of the browser, and system files, configuration files, data files, etc. related with the browser. For example, a system file related with the browser is the file “urlmon.dll”, and a data file related with the browser is a “.dat” file.

In step 220, each time the browser scans a file, it will employ the md5 algorithm to extract a feature content portion in the file, and the feature content can uniquely identify the file. It needs to be noted that the extraction of feature content in the file is not limited to employing the md5 algorithm, and any abstract-of-full-text algorithm such as CRC, md2, md3, md4, etc. may also be employed.

Preferably, the browser will also obtain the file version number, the file size, etc.

In step 230, after the browser scans all the files, a list of current files is generated, and the list of current files contains the feature content of each file.

Preferably, the list of current files further contains a file version number, a file size, etc., and the feature content of each file and its information like the version number and the file size are correspondingly stored.

In step 240, the browser analyzes, according to a list of standard files, the list of current files to check whether the browser has an error or not. Therein, the list of standard files comprises the feature content of correct files. Moreover, the list of standard files may be backed up locally in advance.

In step 250, when one or more items of content in the list of current files do not match the corresponding content in the list of standard files, or when there lack in the list of current files one or more items of content in the list of standard files, it is indicated that a corresponding module has an error, and a module corresponding to the “unmatched file” or the “lacked file” is the erroneous module in the browser and the “unmatched file” or the “lacked file” is the erroneous content. Therefore, this step is a check for the correctness and/or integrality of a module in the browser in order to find an erroneous module in the browser.

Therein, the check for the correctness usually refers to a check about whether information like the file version number, the file size, etc. is consistent with the corresponding content in the list of standard file or not. The check for the integrality usually refers to a check about whether the content of a file has been tampered or not by an abstract-of-full-text algorithm.

In step 260, if the browser has an error, then according to the erroneous module in the browser obtained in step 250, the browser obtains the correct content corresponding to the erroneous content by way of accessing a web page address. Preferably, the obtained content is a configuration file and/or a data file.

In an embodiment of the application, besides the feature content of a correct file, the list of standard files mentioned in steps 240, 250 comprises the download address of the correct file. Therefore, in step 260, the correct content corresponding to the erroneous content may be downloaded from a server side over a network by way of accessing a web page address according to the download address.

In another embodiment of the application, it may also be that a directory storing correct data is preset locally, and a download address for the correct content is found according to the directory. In other words, the download address is stored under the directory in the form of data storage of a file. Therefore, in step 260, the correct content corresponding to the erroneous content is downloaded from a server side over a network by way of accessing a web page address according to the download address.

In step 270, the browser loads directly the obtained content into a system memory, but not stores it locally, and invokes the corresponding correct content directly from the memory when the module is used.

It needs to be noted that, the application is not limited to detecting only by the browser whether itself has an error, and it may also be that it is detected by a server side of the browser whether the browser has an error, and then the detection result is sent to the browser. The particular detection method is identical to that in steps 210 to 250, and will not be repeated here.

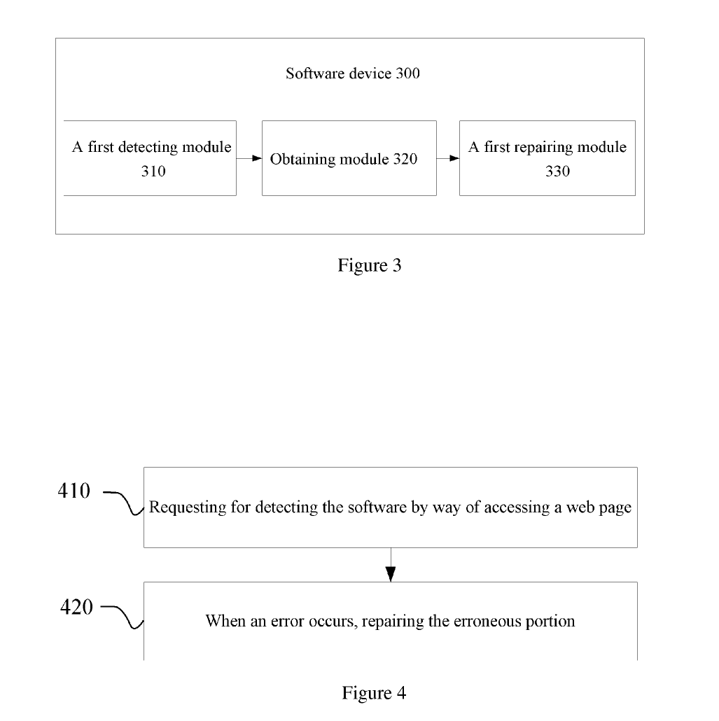

FIG. 3 is a block diagram of a software device for self-repair in an embodiment of the application. The software device 300 comprises a first detecting module 310, an obtaining module 320, and a first repairing module 330. In an example, the software device 300 is a browser.

The first detecting module 310 is adapted to detecting the software, and finding an erroneous module in the software when an error occurs to the software. Preferably, the first detecting module 310 checks the correctness and/or integrality of part of or all the modules in the software.

When a module in the software has an error, the obtaining module 320 obtains the correct content corresponding to the erroneous content by way of accessing a web page address according to the erroneous module obtained by the first detecting module 310. Preferably, the content obtained by the obtaining module 320 is a configuration file and/or a data file.

The first repairing module 330 is adapted to loading directly the obtained correct content into a system memory, but not storing it locally, and invoking the corresponding correct content directly from the memory when the module is used.

What is illustrated in the above embodiment is an example in which software is detected locally, and when an error occurs to the software, the erroneous module in the software is found and automatically repaired. In addition, the software may also be detected and repaired in the form of a request, for which a particular embodiment is as shown in FIG. 4.

FIG. 4 is a flow chart of a method for self-detection in software in another embodiment of the application.

In step 410, requesting for detecting the software by way of accessing a web page address.

In step 420, when it is detected that a module in the software has an error, the corresponding erroneous portion is repaired.

Since this embodiment is capable of self-detecting the software without a manual check, an error may be found more timely and accurately, and the user's experience is better.

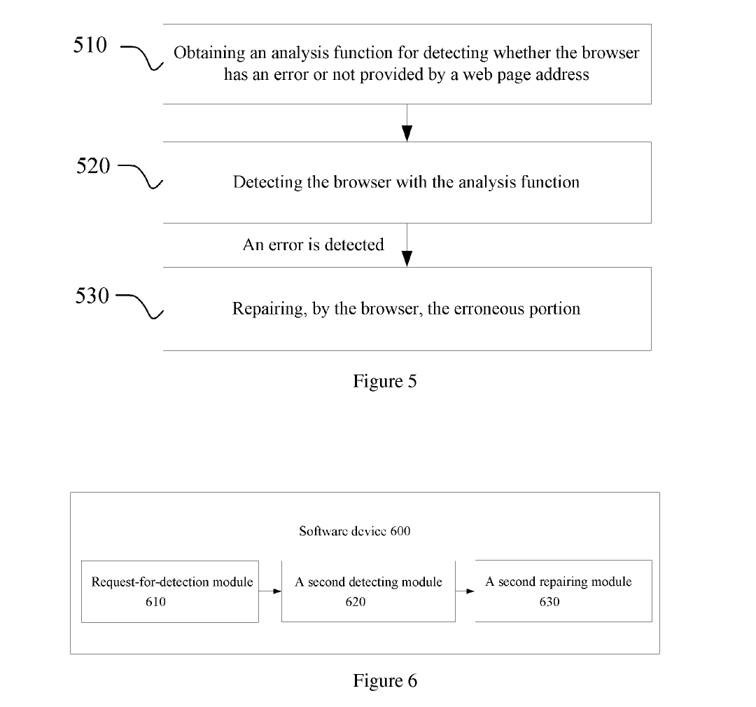

It needs to be noted that, the software in the application may be any software device such as a browser, a chat tool, or a mailbox client, etc. In FIG. 5, a browser is taken as an example to further elucidate the method for repair in software in FIG. 4.

FIG. 5 is a flow chart of a method for self-detection in a browser in another embodiment of the application.

It needs to be noted that, the browser may be self-detected regularly (e.g., one week), may also be self-detected each time it is started, and may still be self-detected according to a detection instruction issued by a user.

In step 510, the browser obtains an analysis function for detecting whether it has an error or not provided by a web page address. Preferably, the analysis function is a function compiled in the javascript language provided by a url.

In step 520, the browser detects whether it is normal or not utilizing the analysis function, and such detection is a check for the correctness and/or integrality of part of or all the modules in the browser.

The particular check method is as follows:

(1) all the files related with the browser are scanned, including a configuration file and/or a data file, and each time a file is scanned, an abstract-of-full-text algorithm will be employed to extract a feature content portion in the file, and the feature content can uniquely identify the file;

(2) after the analysis function scans all the files, a list of current files is generated, and the list of current files contains the feature content of each file;

(3) the list of current files is analyzed according to a list of standard files to check whether the browser has an error or not and the erroneous module in the browser is learned, wherein the list of standard files comprises the feature content of correct files, and preferably also comprises a download address of the correct content;

(4) when one or more items of content in the list of current files do not match the corresponding content in the list of standard files, or when there lack in the list of current files one or more items of content in the list of standard files, it is indicated that the browser has an error, and the erroneous module in the browser is learned according to the matching result.

In step 530, when it is detected that the browser has an error, the browser repairs the corresponding erroneous portion.

Preferably, the browser obtains the correct content corresponding to the erroneous content by way of accessing a web page address. More preferably, the browser loads the obtained correct content directly into a system memory, but not stores it locally, and invokes the corresponding correct content directly from the memory when the module is used.

In an embodiment of the application, before it is requested to detect the software by way of accessing a web page address, it may also be judged in advance whether the software is normal or not. If the software is abnormal, then it is requested to detect the software by way of accessing a web page address; or, it may also be that the software is requested to be detected by way of accessing a web page address according to a detection instruction issued by a user. Therein, it may be judged according to the registry whether the software is normal or not; and if the content in the registry has been modified, then it is indicated that the software is abnormal.

It needs to be noted that, such a judgment is a relatively simple error judgment, and cannot locate each erroneous module and the corresponding erroneous content very accurately, whereas the software detection utilizing an analysis function can do this.

FIG. 6 is a block diagram of a software device for self-detection in another embodiment of the application. The software device 600 comprises a request-for-detection module 610, a second detecting module 620, and a second repairing module 630. In an example, the software device 600 is a browser.

The request-for-detection module 610 requests to check the software by way of accessing a web page address. Further, the request-for-detection module 610 carries out the check for the detection by obtaining an analysis function for detecting that the software has an error provided by the web page address.

The second detecting module 620 is adapted to detecting whether the software is normal or not, and if the software is abnormal, requesting for detecting the software by way of accessing a web page address, or according to a detection instruction issued by a user, requesting for detecting the software by way of accessing a web page address. Preferably, the second detecting module 620 checks the correctness and integrality of part of or all the modules in the software.

When it is detected that a module in the software has an error, the second repairing module 630 repairs the corresponding erroneous portion.

Further, the second repairing module 630 obtains the correct content corresponding to the erroneous content by way of accessing a web page address in order to repair the erroneous portion. Still further, the second repairing module 630 loads directly the obtained content into a system memory, but not stores it locally, and invokes the correct content directly from the memory when the module is used.

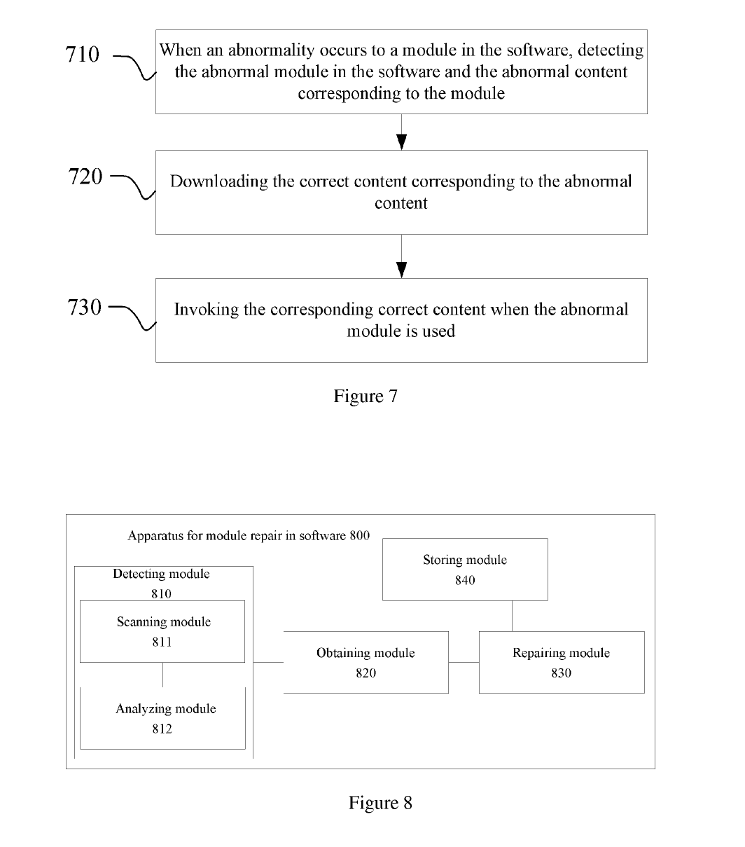

In conclusion, through illustration of the multiple embodiments in FIGS. 1 to 6, the method for self-repair in software provided by the application may be generally summarized as the following processing steps as shown in the embodiment in FIG. 7.

In step 710, when an abnormality occurs to a module in the software, detecting the abnormal module and the abnormal content corresponding to the module.

The abnormality is namely an error, the abnormal module is namely an erroneous module, and the abnormal content is namely erroneous content.

Therein, two detection modes are provided, in which

one mode is that, as described in the embodiments in FIGS. 1, 2, and 3, the detection is performed by detecting the software locally, and when it is detected that the software is abnormal, the abnormal module in the software is found and automatically repaired;

another mode is that, as described in the embodiments in FIGS. 4, 5, and 6, the software is requested to be detected by way of accessing a web page address. In particular, an analysis function for detecting that the software is abnormal is downloaded through the web page address, and the software is detected with the analysis function. Preferably, before it is requested to detect the software by way of accessing a web page address, it may also be judged in advance whether the software is normal or not. If the software is abnormal, then it is requested to detect the software by way of accessing a web page address; or, the software is requested to be detected by way of accessing a web page address according to a detection instruction issued by a user.

It needs to be noted that, for local detection or detection by request, the particular detection process is the same, namely,

(1) all the files related with the software are scanned, including a configuration file and/or a data file, and each time a file is scanned, an abstract-of-full-text algorithm will be employed to extract a feature content portion in the file, and the feature content can uniquely identify the file;

(2) after the analysis function scans all the files, a list of current files is generated, and the list of current files contains the feature content of each file;

(3) the list of current files is analyzed according to a list of standard files to check whether the software has an error or not and the erroneous module in the browser is learned, wherein the list of standard files comprises the feature content of correct files, and preferably also comprises a download address of the correct content;

(4) when one or more items of content in the list of current files do not match the corresponding content in the list of standard files, or when there lack in the list of current files one or more items of content in the list of standard files, it is indicated that the software is abnormal, and the abnormal module in the software is learned according to the matching result.

In step 720, downloading the correct content corresponding to the abnormal content.

The correct content is namely the normal content. The normal content corresponding to the abnormal content may be downloaded by way of accessing a web page address.

In step 730, invoking the corresponding correct content when the abnormal module is used.

Preferably, before step 730, it may also be that the downloaded correct content is loaded directly into a system memory, and then the corresponding correct content is invoked directly from the memory when the erroneous module is used.

Based on FIG. 7, the application also provides a corresponding apparatus embodiment, as shown in FIG. 8, which is a structure diagram of the apparatus for module repair in software in an embodiment of the application.

The apparatus 800 for module repair in software may comprise the following modules:

a detecting module 810 configured to, when an abnormality occurs to a module in the software, detect the abnormal module in the software and the abnormal content corresponding to the module;

an obtaining module 820 configured to download the correct content corresponding to the abnormal content; and

a repairing module 830 configured to invoke the corresponding downloaded normal content when said abnormal module is used.

Preferably, the apparatus may further comprise:

a storing module 840 configured to load directly the downloaded correct content into a system memory; and

then the repairing module 830 invokes directly from the memory the corresponding correct content when said abnormal module is used.

Preferably, the obtaining module downloads the normal content corresponding to the abnormal content by way of accessing a web page address.

Preferably, the detecting module 810 may comprise a scanning module 811 and an analyzing module 812.

The scanning module 811 is configured to scan files related with the software, and each time a file is scanned, to extract a feature content portion in the file, and generate a list of current files.

The analyzing module 812 is configured to match a list of standard files with the list of current files, and when one or more items of content in the list of current files do not match the corresponding content in the list of standard files, or when there lack in the list of current files one or more items of content in the list of standard files, judge that the software is abnormal, and a module corresponding to the unmatched content or the lacked content is an abnormal module in the software and the unmatched content or the lacked content is abnormal content.

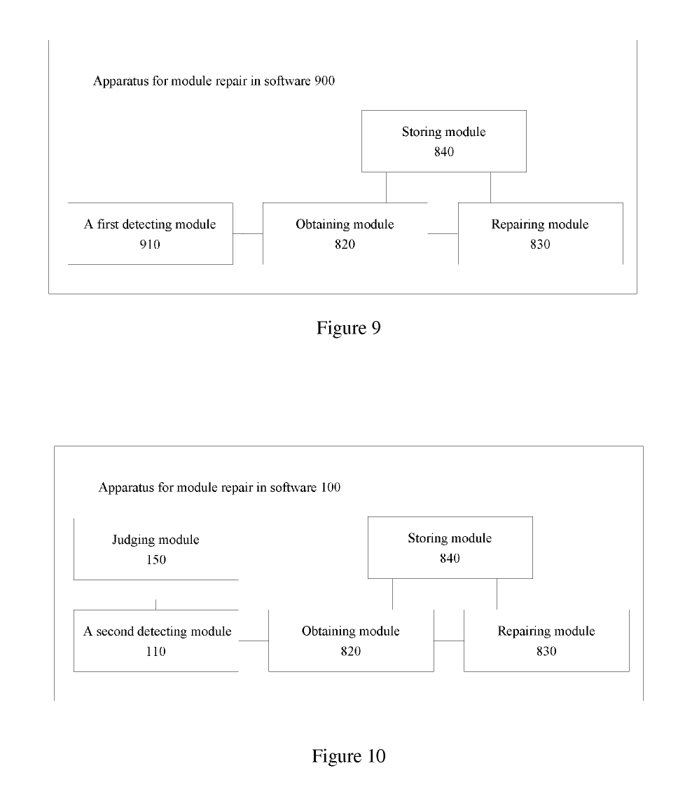

Preferably, in another embodiment of the application, as shown in FIG. 9, the detecting module 810 may be a first detecting module 910, and the first detecting module 910 detects the software locally.

Preferably, in another embodiment of the application, as shown in FIG. 10, the detecting module 810 may also be a second detecting module 110 requesting for detecting the software by way of accessing a web page address. The second detecting module 110 downloads through the web page address an analysis function for detecting an abnormality in the software, and detects the software with the analysis function.

Preferably, when the detecting module 810 is the second detecting module 110, also comprising the following module:

a judging module 150 configured to judge whether the software is normal or not; and

if the software is abnormal, the second detecting module 110 requests for detecting the software by way of accessing a web page address, or according to a detection instruction issued by a user, the second detecting module 110 requests for detecting the software by way of accessing a web page address.

Based on what is described above, the application further provides a computer readable record medium recording thereon a program for carrying out the method for module repair in software, wherein the particular content with respect to the method for module repair in software may be referred to what is described in the embodiments of FIGS. 1, 2, and 4, 5, and 7, and will not be repeated here.

The computer readable record medium comprises any medium for storing or transmitting information in a machine (e.g., a computer) readable form. For example, a machine readable medium comprises a read-only memory (ROM), a random access memory (RAM), a magnetic disk storage medium, an optical storage medium, a flash storage medium, a transmission signal in the form of electricity, light, sound or others (e.g., a carrier wave, an infrared signal, a digital signal, etc.), etc.

It needs to be noted that the application is not limited to be used only in a PC (personal computer), and it may also be applied in a variety of electronic devices such as a PDA (personal digital assistant), a mobile phone, etc. Furthermore, the information transmission way in the application may be wired, and may also be wireless.

The application may be described in the general context of a computer executable instruction executed by a computer, e.g., a program module. In general, the program module comprises a routine, program, object, component, data structure, etc. performing a specific task or implementing a specific abstract data type. The application may also be practiced in distributed computing environments, in which a task is performed by a remote processing device connected by a communications network. In a distributed computing environment, the program module may be located in a local and remote computer storage medium comprising a storage device.

Finally, it also needs to be noted that, in this text, a relational term such as first and second, etc. is used only to distinguish one or some entities or operations from another or some other entities or operations, and it is not necessarily required or indicated that there exists any such a relation or order between these entities or operations.

Moreover, “and/or” in the above means that the relation of “and” is included, and the relation of “or” is also included, wherein if there exists a relation of “and” between a scheme A and a scheme B, it means both the scheme A and the scheme B may be included simultaneously in a certain embodiment; if there exists a relation of “or” between the scheme A and the scheme B, it means in a certain embodiment, the scheme A may be included individually, or the scheme B may be included individually.

Clearly, there may be many variations to the application described herein without departing from the true spirit and scope of the application. Therefore, all changes evident to those skilled in the art should be embraced within the scope encompassed by the claims. The scope claimed by the application is only defined by the claims.

1. A method for module repair in software, comprising:
when an abnormality occurs to a module in the software, detecting the abnormal module in the software and the abnormal content corresponding to the module;
downloading the normal content corresponding to the abnormal content; and
invoking the corresponding downloaded normal content when said abnormal module is used.

2. The method for module repair in software as claimed in claim 1, further comprising, after the step of downloading the normal content corresponding to the abnormal content,
loading directly the downloaded normal content into a system memory;
then the step of invoking the corresponding downloaded normal content when said abnormal module is used is: invoking directly from the memory the corresponding downloaded normal content when said abnormal module is used.

3. The method for module repair in software as claimed in claim 1, wherein
the normal content corresponding to the abnormal content is downloaded by way of accessing a web page address.

4. The method for module repair in software as claimed in claim 1, wherein the downloaded normal content is a configuration file and/or a data file.

5. The method for module repair in software as claimed in claim 1, wherein the detecting step is checking for the correctness and/or integrality of part of or all the modules in the software.

6. The method for module repair in software as claimed in claim 1, wherein the detecting step comprises a step of scanning files related with the software.

7. The method for module repair in software as claimed in claim 5, wherein the scanning step comprises a step of extracting feature content portions in the files and generating a list of current files.

8. The method for module repair in software as claimed in claim 7, wherein the extraction of feature content portions employs an abstract-of-full-text algorithm.

9. The method for module repair in software as claimed in claim 7, wherein the detecting step further comprises a step of analyzing the list of current files according to a list of standard files.

10. The method for module repair in software as claimed in claim 9, wherein the analyzing step comprises:
matching the list of current files with the list of standard files, and when one or more items of content in the list of current files do not match the corresponding content in the list of standard files, judging that the software is abnormal, and a module corresponding to the unmatched content is an abnormal module in the software and the unmatched content is abnormal content.

11. The method for module repair in software as claimed in claim 9, wherein the analyzing step comprises:
matching the list of current files with the list of standard files, and when there lack in the list of current files one or more items of content in the list of standard files, judging that the software is abnormal, and a module corresponding to the lacked content is an abnormal module in the software and the lacked content is abnormal content.

12. The method for module repair in software as claimed in claim 9, wherein the list of standard files comprises the feature content portion of a correct file and a download address containing the correct file.

13. The method for module repair in software as claimed in claim 1, further comprising, before the step of downloading the normal content,
presetting locally a directory storing correct data, and finding a download address of the normal content according to the directory of correct data.

14. The method for module repair in software as claimed in claim 1, wherein the step of detecting comprises:
detecting the software locally.

15. The method for module repair in software as claimed in claim 1, wherein the step of detecting comprises:
requesting for detecting the software by way of accessing a web page address.

16. The method for module repair in software as claimed in claim 15, wherein the requesting for detecting the software by way of accessing a web page address comprises:
downloading through the web page address an analysis function for detecting an abnormality in the software; and
detecting the software with the analysis function.

17. The method for module repair in software as claimed in claim 15, further comprising, before the requesting for detecting the software by way of accessing a web page address,
a step of judging whether the software is normal or not, and
if the software is abnormal, the detection of the software is requested by way of accessing a web page address, or according to a detection instruction issued by a user, the detection of the software is requested by way of accessing a web page address.

18. An apparatus for module repair in software, comprising:
a detecting module configured to, when an abnormality occurs to a module in the software, detect the abnormal module in the software and the abnormal content corresponding to the module;
an obtaining module configured to download the normal content corresponding to the abnormal content; and
a repairing module configured to invoke the corresponding downloaded normal content when said abnormal module is used.

19. The apparatus for module repair in software as claimed in claim 18, further comprising:
a storing module configured to load directly the downloaded normal content into a system memory; and
then the repairing module invokes directly from the memory the corresponding downloaded normal content when said abnormal module is used.

20. The apparatus for module repair in software as claimed in claim 18, wherein
the obtaining module downloads the normal content corresponding to the abnormal content by way of accessing a web page address.

21. The apparatus for module repair in software as claimed in claim 18, wherein the detecting module comprises:
a scanning module configured to scan files related with the software, and each time a file is scanned, extract a feature content portion in the file, and generate a list of current files; and
an analyzing module configured to match a list of standard files with the list of current files, and when one or more items of content in the list of current files do not match the corresponding content in the list of standard files, or when there lack in the list of current files one or more items of content in the list of standard files, judge that the software is abnormal, and a module corresponding to the unmatched content or the lacked content is an abnormal module in the software and the unmatched content or the lacked content is abnormal content.

22. The apparatus for module repair in software as claimed in claim 21, wherein the detecting module is a first detecting module which detects the software locally.

23. The apparatus for module repair in software as claimed in claim 21, wherein the detecting module is a second detecting module which requesting for detecting the software by way of accessing a web page address, and the second detecting module downloads through the web page address an analysis function for detecting an abnormality in the software, and detects the software with the analysis function.

24. The apparatus for module repair in software as claimed in claim 23, further comprising, when the detecting module is the second detecting module,
a judging module configured to judge whether the software is normal or not; and
if the software is abnormal, the second detecting module requests for detecting the software by way of accessing a web page address; or according to a detection instruction issued by a user, the second detecting module requests for detecting the software by way of accessing a web page address.

25. A computer readable record medium recording thereon a program for carrying out the method as claimed in claim 1.
